(19) United States
(12) Patent Application Publication
(10) Pub. No.: US 2003/0047596 A1
(43) Pub. Date: Mar. 13, 2003

(54) Voting machine and method of use

(76) Inventor: Andrew Brown, Greenville, SC (US)

Correspondence Address: Joseph T. Guy, Nexsen Pruet Jacobs & Pollard L.L.C., P.O. Box 10648, Greenville, SC, 29603-0648, US

(21) Appl. No.: 09/950,113

(22) Filed: Sep. 10, 2001

(51) Int. Cl. G07C 13/00

(52) U.S. Cl. 235/51

(57) ABSTRACT

A voting machine is described comprising an image of a candidate. A button, corresponding to the image of the candidate, is engaged to choose the candidate. The image is displayed in a verification window after the button is engaged. A confirmation mechanism is engaged to affirm that the image in the verification window is correct and to irreversibly tally a vote for the candidate.

### TECHNICAL FIELD

The present invention is related to a voting machine and method of use. More particularly this invention is related to a voting machine which allows for positive confirmation of a vote prior to the vote being cast.

### BACKGROUND

Voting is now a right in many jurisdictions and a privilege which is not taken lightly by many citizens. While the right, and ability, to vote is widely granted the integrity of the vote is often suspect and verification of the accuracy of the votes cast is of utmost concern. Automatic counting techniques are in widespread use. The more common methods of automatic counting involve one of two voting systems.

In one method of automatic counting a physical ballot is marked, or punched in an area corresponding to a particular candidate. The mark can be read by a scanner as well known in the art of testing and the like. A punch mark can be read by a reader as well known in the now archaic art of punch card readers. Both of these methods are inferior for various reasons. Stray marks can confuse the reader thereby rendering a ballot which may not reflect the intentions of the voter. Inadequate punching of a ballot can leave a chad which is either not removed or inadequately removed. Both of these methods require handling which allows for the possibility of fraud and tampering. Furthermore, if a recount is required the ballots may lose integrity. Continued handling may cause marks to smear or chads can become dislodged thereby altering the original ballot in ways which are not easily ascertained. This has led to considerable confusion in close elections.

An alternative method of automatic counting requires the use of computers attached to touch screens, digital styluses or other techniques capable of converting an indication on a screen to a response which indicates a cast vote. These methods are superior to physical ballots since there is no handling or manipulation. This method still has problems since it is not always clear that a vote is cast for a particular person or as desired for a particular issue. Backlit buttons, or indicator lights can often be confusing and may misinform the voter with regards to the actual vote cast versus the intentions of the voter. Furthermore, if a mechanical malfunction occurs such as loss of electrical power or loss of a communication link between the voting panel and the computer the voter may have no indication that the vote was not registered. In the event of a contested election there is virtually no ability to recount the votes since there is no way to correlate the intention of the voter with the indication received by the computer. Yet another concern is the integrity of electronic recording systems since they can conceivably be manipulated in such a way as to augment the vote of one candidate over another in a fraudulent manner. Detection of fraud of this type is difficult to detect.

A common problem with all current voting methods is the inability of the voter to correlate names with physical appearance. It is now common for a particular candidate to be visible through various media outlets wherein the visual recognition of the candidate is enhanced. It is also common for a candidate to receive an alias, or nickname, which becomes more familiar to the voters than the legal name. When the voter reaches the ballot box the full legal name is often listed on the ballot which may be confusing since it is rare to refer to the candidate by the full legal name prior to the election.

The present invention provides an improved apparatus for voting and a method which eliminates the problems commonly realized in voting systems currently available.

### SUMMARY

It is an object of the present invention to provide a voting machine, and method for use, which allows for greater certainty of the vote cast.

It is another object of the present invention to provide a voting machine, and method for use, which utilizes images of the candidate, or issue, and an optional audible signal thereby increasing the ease with which illiterate and handicapped people can vote without assistance.

It is another object of the present invention to provide a voting machine which records each vote on media and separately transmits the vote to a collector. This allows for accurate recounts when required in close elections.

A particular feature of the present invention is the ability of the voter to insure that the proper vote has been cast prior to casting the vote and that the proper vote has been recorded.

These and other features, as will be apparent, are provided in a voting machine comprising an image of a candidate. A button, corresponding to the image of the candidate, is engaged to choose the candidate. The image is displayed in a verification window after the button is engaged. A confirmation mechanism is engaged to affirm that the image in the verification window is correct and to irreversibly tally a vote for the candidate.

Another embodiment is provided in a method for voting in an election. The method comprises viewing an image of a candidate on a voting machine. After viewing the images a choice mechanism is engaged wherein the choice mechanism corresponds to the image of the candidate. The image is viewed on a verification screen to confirm the vote for the candidate.

Another embodiment is provided in a voting machine for choosing one item from a list of items. The voting machine comprises a visible image of the item. A choice mechanism is engaged to choose the item from the list of items. A verification device displays the visible image of the item chosen. A confirmation mechanism is engaged for tallying a vote for the item and a recorder records the image.

Another embodiment is provided in a voting machine which comprises an image of a candidate. A button, corresponding to the image of the candidate, is engaged to choose the candidate. A verification window is provided wherein the image appears when the button is engaged. A confirmation mechanism is engaged to affirm that the image in the verification window is correct and the confirmation mechanism irreversibly tallies a vote for the candidate. A recorder records the image on media when the vote is tallied. A communication device transmits a signal to a collector wherein the signal corresponds to the candidate.

### BRIEF DESCRIPTION OF THE DRAWINGS

FIG. 1 is a partial cutaway view of a voting machine of the present invention.

FIG. 2 is a perspective view of an embodiment of the voting machine of the present invention.

FIG. 3 is a perspective view of another embodiment of the voting machine of the present invention.

### DETAILED DESCRIPTION

The invention will be described with reference to the drawings wherein similar elements are numbered accordingly.

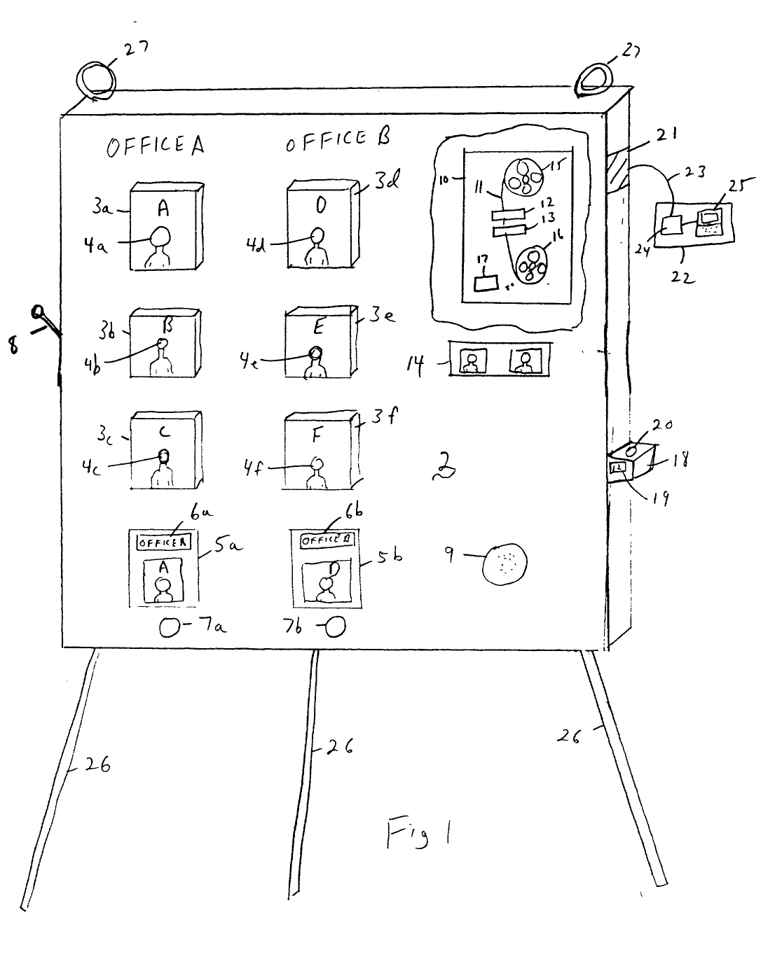

A voting machine, represented in partial cutaway at 1, is illustrated in FIG. 1. The voting machine comprises a face, 2. The voting machine may be used for multiple offices such as, for example, Office A and Office B or items in an election. Each office may have multiple candidates. A button, 3, corresponding to each candidate is preferably attached to the face. Associated with each button, 3, is an image of the candidate, 4, and the name of the candidate. For the purposes of illustration each candidate name is represented by a letter. It would be understood that, in most elections, a candidate for Office A could only be selected for Office A and a candidate for Office B could only be selected for Office B.

When a button is engaged the image, 4, appears in a verification window, 5. For the purpose of illustration if button 3a is engaged, indicating a desire to select candidate A as the choice for Office A, image, 4a, appears in the verification window, 5a. Similarly, if button 3d is engaged, indicating a desire to select candidate D for Office B, image 4d appears in the verification window, 5b. The verification window is preferably integral to the face. In a preferred embodiment both the image and the candidates name appear in the verification window. It is also preferred that the office for which the candidate has been selected appears in an office verification window, 6. The office verification window, 6, may be the same window as the verification window or separate. In an alternative embodiment the verification window and buttons may be arranged in such a fashion that the proximity of the verification window clearly indicates for which office the candidate has been chosen. If the image appearing in the verification window is correct and acceptable an office confirmation mechanism, 7, may be engaged to record the vote. It is most desirable that after the office confirmation mechanism is engaged the vote is irreversibly recorded. In an alternative embodiment, a global confirmation mechanism, 8, may be provided for engaging all votes simultaneously. In a particularly preferred embodiment, the global confirmation mechanism, 8, is a lever arm similar to that associated with a slot machine or the like. The global confirmation arm preferably has a variable resistance such that the further the arm is moved the higher the resistance to movement. This can be accomplished by springs, which are biased towards the neutral position and stretched as the arm is moved towards recording a vote.

An optional, but preferred, audible alarm, 9, may be employed wherein an audible signal is provided which corresponds to the candidates. For example, if button 3a is engaged, the audible alarm may say, for example “Candidate A for Office A”. Similarly if button 3e is engaged the alarm may say, for example “Candidate E for Office B”. The audible alarm allows for voting without the necessity to read a name, or see, the candidate image. In a particularly preferred embodiment, the voter may engage each button for an office and return to the candidate of choice. As each button is engaged that candidate appears in the verification window displacing any previous image therein. If for example, button 3a is engaged and this candidate is not the choice of the voter a different button can be engaged and the image will be replaced. In one embodiment the office confirmation mechanism can be engaged to provide an audible alert as to the candidate image in the verification window but the vote may not be cast until the global confirmation mechanism, 8, is engaged. The audible alarm is preferably a speaker and may be integral to the face, 2, or it may be remote and incorporated into a headphone for privacy. The audible alarm may also provide instruction regarding the candidate selection process and the manner in which the voting machine operates. In a particularly preferred embodiment, the audible alarm may play a prerecorded sound or message indicating that the global confirmation mechanism has been engaged and the vote is tallied. A variable bell sound which has alterations in pitch and/or volume can be employed. In a particularly preferred embodiment the global confirmation mechanism activates a sound which changes as the arm is moved from a neutral position to record the vote. For example, a digital or mechanical bell could sound which changes pitch and/or volume with movement of the global confirmation mechanism. In a particularly preferred embodiment the audible alarm generates a sound when the global confirmation mechanism is engaged which has a familiar “Ka-Ching” sound associated with slot machines, manual cash registers and the like.

It is preferred that the vote cast be recorded. In an embodiment of the present invention a recorder, 10, records the image on a media, 11. The image is recorded by an image printer, 12. In a particularly preferred mode, the printer, 12, prints a visible image such as common with laser printers, thermographic printers, dye sublimation printers, ink jet printers and the like. The image can then be read by a reader, 13, and displayed in a final verification window, 14. This allows the voter to confirm that the vote was cast, and recorded properly prior to exiting the voting location. The final verification window may display all choices for all offices or the images may be displayed sequentially. The media is preferably supplied on a feed roller, 15, and received on a take-up roller, 16, as would be realized to one of ordinary skill in the art. Other methods for media transport could be utilized without departing from the scope of the present invention. This imaged media represents a redundant vote count which may be used to confirm the actual count transmitted as described herein. Furthermore, the imaged media may be used as a back-up primary count in the event of a communication failure such as a phone line disruption or power loss at the collector. The recordation of votes cast on an imaging media creates a permanent record for recount which is less susceptible to fraud than existing systems. Particularly, the combination of a physically recorded vote in combination with a touch screen allows for recount and verification of the electronic recordation which otherwise could be subject to manipulation and fraudulent intent wherein a vote is skewed to one candidate over another. This is accomplished without eliminating the advantages provided by an electronic voting system.

A counter, 17, coupled to the image printer, 12, is preferably provided to count the number of images recorded thereby insuring that the media is replaced as needed. In a particularly preferred embodiment the number of images is displayed on a display device, 18, which preferably comprises a digital display, 19, and an optional alert device, 20, such as a light or audible alarm to indicate the necessity for replacing media.

A communication device, 21, transmits the vote cast to a collector, 22, via a communication link, 23. The communication device is any device known in the art for transmitting digital information including modems, data ports, and the like. The communication link can be a twisted cable pair, an optical pipe or a terrestrial transmission commonly employed in communication, particularly communication between digital devices. In a particularly preferred embodiment the communication device is a modem which transmits a signal to a receiver modem, 24, of the collector, 22, wherein the data is received by a computer, 25. The communication link may be a telephone link directly between modems or a network, such as the world wide web, with a routing address to the receiver modem. The collector may tally the votes of a single voting machine, those of a single precinct, those of a single county, those of a state, or any jurisdiction based on the convenience and cost factors associated with the collection process. The votes may be collected individually or they may be bundled to optimize communication.

An optional, but preferred, card reader, 28, can be used in conjuction with a voter card. The voter card can indicate a voter identifier which is read by the card reader to confirm eligibility to vote. In one embodiment the offices and candidates therefore can be altered to the specific voter thereby allowing a voter to cast ballots in a different voting location then the one to which they are assigned. By incorporating voting cards the individual voter may still cast ballots for candidates or issues which are specific to their assigned precinct while casting the ballot from any location. This is presently not available. For example, a voter may cast a vote for president in one state while still having the vote count in the state to which they are registered. This greatly enhances the ease with which individuals can participate in the voting process while decreasing the reliance on absentee ballots.

Legs, 26, and carrying rings, 27, may be employed to improve the transportability of the voting machine. It would be realized to a skilled artisan that curtains, shields, or other privacy features may be incorporated without departing from the scope of the present invention.

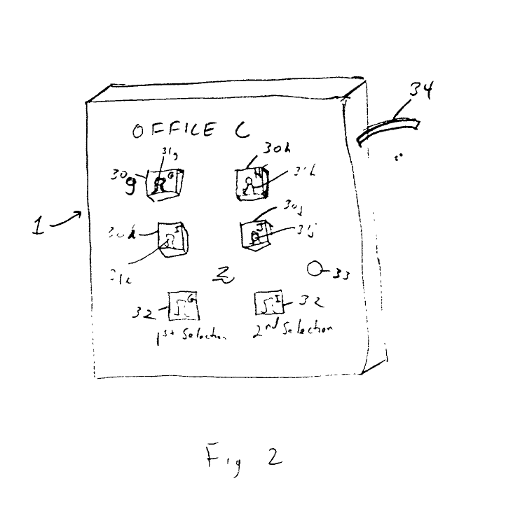

FIG. 2 is a perspective view of an embodiment of the present invention wherein multiple choices are available for a particular office. In the embodiment illustrated in FIG. 2 there are four candidates, each represented by a button, 30. Each button comprises a visual image, 31, of the candidate or item to be selected. In the embodiment illustrated in FIG. 2, there are two available positions to be filled. In an election where multiple candidates may be chosen there may be multiple verification windows, 32, with one verification window per available position. For example, if two candidates can be elected for Office C, there could be two verification windows as illustrated in FIG. 2. When the correct images are in the verification windows, 32, the confirmation mechanism, 33, is engaged. The image is recorded and transmitted over communication link, 34.

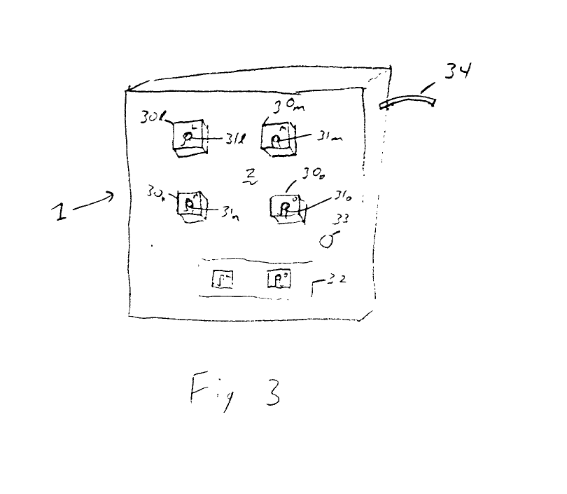

FIG. 3 is a perspective view of an embodiment of the present invention. In FIG. 3, the voting machine, 1, comprises a verification window, 32, which can display multiple images. The candidates selected appear in the verification window. Once the selection is complete the confirmation mechanism, 33, is engaged and the vote is transmitted over a communication link, 34.

The button is an element which can be engaged to indicate the choice of the voter. Buttons are well known in the art to include such devices as keys, as on a computer keyboard, wherein engaging the button closes a circuit thereby allowing current to flow to the appropriate components. Other buttons could be employed without departing from the scope of the present invention such as touch screens wherein a finger, or stylus, engages a screen to indicate a selection. Examples include electronic notebooks or styluses, as illustrated, for example, in U.S. Pat. Nos. 5,049,862; 5,243,149; 5,313,051 and references cited therein. Other devices utilizing bidirectional locating touch pads, such as described in U.S. Pat. No. 5,543,589 or references cited therein may be utilized.

The image is a visual representation of the element to be selected. For elections of people the image may include a photograph, either digital, analog or chemical, of the candidate or slate of candidates for a particular office. For elections on referendums, bond issues, and other matters commonly decided in an election the visual image may include text, representative logos, slogans or representations of the issue at hand. It would be understood that the image is distinctive between candidates, or items up for decision, to insure that a conclusive choice can be made.

The present invention is suitable for any application wherein an item is selected from a set of items. While intended for elections wherein candidates, or slates of candidates, are elected this invention could be utilized for virtually any application wherein choices are made between elements. A voting machine may be used for multiple elections wherein several choices can be made at a single voting machine as illustrated and described in reference to FIG. 1. Each voting machine may also be dedicated to a specific election and a voter may transit between voting machines to vote for different offices or issues.

The verification window is a display device which is preferably separate from the button. Any display unit could be employed with the proviso that the image resolution is sufficient to distinguish the images of the candidates. While not limited thereto, particularly preferred displays include liquid crystal displays, cathode ray tube displays, and the like. It is particularly preferred that the verification window be interfaced with a computer wherein a digital image is stored and displayed.

The confirmation mechanism is a device which can be engaged to indicate confirmation of the candidate indicated in the verification window. A contact switch can be employed as can other devices known in the art including such devices as keys, as on a computer keyboard, wherein engaging the button closes a circuit thereby allowing current to flow to the appropriate components. Other buttons could be employed without departing from the scope of the present invention such as touch screens wherein a finger, or stylus, engages a screen to indicate a selection. Examples include electronic notebooks or styluses, as illustrated for example in U.S. Pat. Nos. 5,049,862; 5,243,149; 5,313,051 and references cited therein. Other devices utilizing bidirectional locating touch pads, such as described in U.S. Pat. No. 5,543,589 or references cited therein may be utilized. The confirmation mechanism and button may utilize the same or different technology with the realization to one of ordinary skill in the art that it is often advantageous to utilize common technology in a product to decrease cost and the number of parts required in inventory. In a particularly preferred embodiment, a lever could be employed since this provides a more certain response to the voter than that provided by engaging a button.

The media can be any media common for storing images. Particularly preferred are media which react with radiation to form an image such as silver halide based media, silver behenate based media, thermographic media, photothermographic, compact disk, magnetic media, optical disk and the like. Media which stores an image by receiving an imaging element such as an ink, pigment or dye are imminently suitable for demonstration of the technology described herein such as media for solvent based ink jet, phase change ink jet, dye sublimation, dye transfer and similar technologies.

The image printer is chosen based on cost and print quality with the realization that image quality must be sufficient to distinguish between candidates. The image printer is chosen in conjunction with a compatible media, as would be realized to one of ordinary skill in the art. The image print format is not limiting and may be a full size format wherein the image printed on the media is the same as that displayed or it may be altered such as would be done with microfilm printing and the like. The printer may be digital or analog.

The invention has been describe with emphasis directed to the preferred embodiments. It would be apparent from the description herein that various embodiments could be developed without departing from the scope of the invention. Alternate methods of construction, operation and use could also be employed without departing from the scope of the invention which is set forth in the claims which follow.

Claimed is:

1. A voting machine comprising:
an image of a candidate;
a button corresponding to said image of said candidate wherein said button can be engaged to choose said candidate;
a verification window wherein said image appears when said button is engaged; and
a confirmation mechanism for affirming said image in said verification window is correct and wherein said confirmation mechanism irreversibly tallies a vote for said candidate.

2. The voting machine of claim 1 further comprising an audible device for generating an audible signal corresponding to said candidate.

3. The voting machine of claim 1 further comprising a recorder for recording said image on a media when said vote is tallied.

4. The voting machine of claim 3 further comprising a final verification window for viewing said image stored on said media.

5. The voting machine of claim 3 further comprising a counter capable of recording a number of times said image is recorded on said media.

6. The voting machine of claim 5 further comprising a display device for displaying said number.

7. The voting machine of claim 1 further comprising a communication device for transmitting a signal to a collector wherein said signal corresponds to said candidate.

8. The voting machine of claim 1 wherein said image is a photograph.

9. The voting machine of claim 1 further comprising a card reader for reading a voter card.

10. The voting machine of claim 1 wherein said confirmation mechanism is a global confirmation mechanism.

11. The voting machine of claim 10 wherein said global confirmation mechanism is a lever.

12. A method for voting in an election comprising:
viewing an image of a candidate on a voting machine;
engaging a choice mechanism corresponding to said image of said candidate;
viewing said image in a verification screen; and
confirming said image to tally a vote for said candidate.

13. The method for voting in an election of claim 12 further comprising:
recording said image on a media.

14. The method for voting in an election of claim 13 wherein said recording is prior to said confirming.

15. The method for voting in an election of claim 13 further comprising:
incrementing a counter for said recording of said image on said media.

16. The method for voting in an election of claim 12 further comprising:
transmitting a signal wherein said signal corresponds to said candidate.

17. The method for voting in an election of claim 12 further comprising:
entering voter information prior to said viewing.

18. A voting machine for choosing one item from a list of items comprising:
a visible image of said item;
a choice mechanism which is engaged to choose said item of said list of items;
a verification device which displays said visible image of said item chosen;
a confirmation mechanism for tallying a vote for said item; and
a recorder for recording said image.

19. The voting machine of claim 18 further comprising an audible device for generating an audible signal corresponding to said candidate.

20. The voting machine of claim 18 further comprising a recorder for recording said image on a media when said vote is tallied.

21. The voting machine of claim 18 further comprising a final verification window for viewing said image on said media.

22. The voting machine of claim 20 further comprising a counter capable of recording a number of times said image is recorded on said media.

23. The voting machine of claim 18 wherein said item is a candidate.

24. A voting machine comprising:
an image of a candidate;
a button corresponding to said image of said candidate wherein said button can be engaged to choose said candidate;
a verification window wherein said image appears when said button is engaged;
a confirmation mechanism for affirming said image in said verification window wherein said confirmation mechanism irreversibly tallies a vote for said candidate;
a recorder for recording said image on a media when said vote is tallied; and
a communication device for transmitting a signal to a collector wherein said signal corresponds to said candidate.

25. The voting machine of claim 24 further comprising a final verification window for viewing said image on said media.

26. The voting machine of claim 24 further comprising a counter capable of recording a number of times said image is recorded on said media.

27. The voting machine of claim 24 wherein said image is a photograph.
